(19) United States
(12) Patent Application Publication
(10) Pub. No.: US 2012/0111174 A1
(43) Pub. Date: May 10, 2012

(54) Method for manufacturing a neck for a stringed musical instrument

(76) Inventor: Frederic PORTALET, Bordeaux (FR)

(21) Appl. No.: 13/290,280

(22) Filed: Nov. 7, 2011

(30) Foreign Application Priority Data
Nov. 5, 2010 (FR) 10 59131

(51) Int. Cl. G10D 3/00; B32B 38/10

(52) U.S. Cl. 84/293; 156/153; 216/52

(57) ABSTRACT

A method of manufacturing a guitar neck for a string instrument includes:
a) creating slots in a fretboard;
b) assembling the fretboard thus obtained with a neck (16);
c) inserting in at least certain of the slots, a guide mark element (18, 20) for positioning the player's finger, the guide mark elements (18, 20) being transparent or semitransparent, each including a sign (20), placed at distance d from the upper face of the guide mark element (18, 20); and
d) making the guide mark elements (18, 20) thus fixed flush with the outer surface of the fretboard, the distance d being such that the sign (20) is not flush at the end of this phase.

The present invention concerns the musical training domain, notably that of stringed musical instruments such as guitars. It is more especially concerned with a method of manufacturing a neck for a stringed musical instrument; the neck carries guide marks for learning and playing said musical instrument.

The guitar is a musical instrument that for a beginner player, or an occasional player, may present difficulties in learning and playing.

There are a number of learning methods designed to allow a beginner player to play the guitar more easily. These methods aim at showing players where to place their fingers on the musical instrument's neck in order to play the notes.

Document FR 2601798 thus describes the use of adhesive strips, carrying on their reverse side the name of the note and a colour associated with it. The player also uses a score carrying the notes of the guitar in semitone steps. The score shows the coordinates of each note (which string, and which fret) as well as a colour corresponding to the note.

However such a method suffers from a number of disadvantages.

Firstly, it requires that adhesive paper strips be placed on the fretboard, and such strips can become creased. This is because spacing between the strings and the relatively cramped space between the fretboard and the strings means that placing the strips is a complicated operation.

The only proper way to place the adhesive strips is first to remove the strings of the guitar, in itself a difficult operation for a beginner player, who will find it hard to put the strings back on the neck.

In addition, the adhesive strips are difficult to remove after use, because of the very narrow space between the strings and the fretboard. Removing the adhesive strips may require that the strings be removed yet again.

Another known method for learning consists of placing guide marks on the fretboard.

These guide marks may be in the form of circular metal, mother of pearl or ivory components, that may be fretted into or stuck onto the fretboard. However, such guide marks are relatively elementary, do not allow the player to find the notes and therefore do not allow the player to read the score.

Alternatively, said guide marks may be in the form of painted circles. Each of the circles is given a colour corresponding to a musical note.

However, such guide marks are soon seen to deteriorate, since they possess insufficient protection against wear and tear, and may soon become impossible to see. Among other causes, the integrity of the guide marks can suffer from sweat from the play's fingers and the friction of the strings against the fretboard.

In addition, such guide marks remain elementary, and cannot carry any signing. It is a well-known fact that in the course of manufacture, a guitar fretboard is first rounded out in order to give it the proper radius, and the round form is then polished using the sanding block.

As a result of these operations, the material used for the guide marks is partly removed. Any guide mark on the surface will suffer immediate deterioration or even be altogether eliminated in the course of such operations.

It would therefore be advantageous to possess a manufacturing method for the neck that presents a training aid for the guitar player and that does not suffer from the above-mentioned disadvantages of the art.

The goal of the present invention is thus to propose a guitar neck manufacturing method that is simple, economical and rapid in design and in operating mode, and that makes it possible to leave the guide marks and signing they carry in a perfectly legible condition after the neck manufacturing operations, and thus offer a more complete system for learning or playing the guitar.

Another purpose of the present invention is a neck equipped with a simpler and more rugged system, resistant to outside wear and tear, in order to assist in learning the guitar.

For this purpose, the invention concerns a manufacturing method for a neck of a stringed musical instrument.

According to the invention, at least the following steps are carried out:

a) slots are cut into a fretboard,

b) said fretboard is then assembled with a neck,

c) in at least some of the frets, guide marks are placed for positioning the fingers; such guide marks are transparent or semitransparent; each carries a sign placed at distance d from the other face of said guide mark,

d) said guide marks are made to be flush with the outer surface of said fretboard, said distance d being such that said sign is not flush with the surface at the end of this step of said method.

Preferably, in the course of step a), holes are drilled that emerge in the fretboard, such holes being equal or approximately equal in size to the guide marks.

It is an advantage if the guide marks are made of a single piece of material. In one form, they are made of transparent or semi transparent plastic material. For example, the plastic material is polymethyl methacrylate (PMMA). The guide marks can also be created using an injection method.

Alternatively, the guide marks can be made of resin.

The fretboard is preferably made from a plank of hardwood. In one form, the fretboard is made of ebony, rosewood or maple. Alternatively, it can be made of composite materials and may for example include carbon fibres. It can also be made of obomol.

The method of the present invention has an advantage in that it provides ongoing extended assistance in learning and playing the guitar.

Said guide marks carried out in various colours also give a more pleasing aesthetic aspect to the guitar.

It is understood that said steps of a method for manufacturing the invention are not shown in their successive order. Thus it is possible to drill the holes in the fretboard after having assembled said fretboard with the guitar neck in order to make the slots that will house the guide mark elements.

Various manufacturing modes for said method each have their own advantages that may be technically combined in a number of ways:
after step d), the neck thus obtained as described is fretted;
   In the course of this step, the frets are placed and assembled on the fretboard of a stringed musical instrument. The ends of the frets are made flush with the lateral edges of the fretboard; the ends of said frets may then be polished. Preferably, before assembling the frets with said fretboard, grooves may be made on said fretboard before carrying out step a); the grooves will correspond to the position of the frets on the fretboard.
   This step also provides an opportunity to mark the frets on the fretboard as well as where the guide marks should be on said fretboard.

Alternatively, it is also possible to mark off the borders of said fret slots on the fretboard using marks that may or may not be erasable; and to create said grooves subsequently.
after step b) and before step c), the fretboard is given a rounded shape in order to form the radius,
said fret slots being holes in which said guide marks are inserted, both the lower face of the guide mark elements and the lower face of the fretboard are treated with glue, ready to be assembled with the neck,
said signings are letters, figures or combinations of the said elements,
   Such signings can also include pictograms or symbols.
in the course of step a), slots are created in positions that define notes perpendicular or nearly perpendicular to the strings to be placed.

Depending on the size to be given to said guide marks, said slots can also be hollowed out spaces in the fretboard that may or may not be pierced.

The invention also concerns a stringed musical instrument equipped with a neck obtained by the manufacturing method described previously.

Preferably, guide marks on said fretboard are coloured plastic pellets, said signings being placed within the volume of such pellets or on their lower face, for positioning in the slots created on the fretboard in the course of step a).

Such signings being created by etching or brushing of the extremities of said marks destined for positioning in said slots, said marks are fixed in the slots by gluing, which improves visibility of said signings.

Similarly, said invention concerns a guitar neck, said guitar neck comprising a fretboard.

According to the invention, said fretboard is encrusted with pellets the colours of which represent a note; said pellets are encrusted into each of the slots of the notes, in the middle of said slot and under the string; said pellets, comprising a sign corresponding to the note, said sign being oriented in such a way as to be visible to the player.

Said sign is selected purely by way of illustration from among letters, figures, pictograms and symbols, or any combination of said elements.

The invention also concerns a guitar equipped with a neck obtained through the manufacturing method previously described.

Said guitar may be a classical guitar, the neck in this case being attached to the body by means of a heel made up of a piece of cemented wood.

Alternatively, said guitar is an electric guitar. Such a neck in this case can then be screwed or riveted to the body of the guitar. Said neck can be of a type known as “conducting” or “crossover”. This element goes through the body of the instrument and/or the sounding board.

Strings of said guitar may be of nylon, silicon or can be metallic. In the latter case, the strings may be bronze or nickel for example.

The invention shall be described in greater detail in reference to accompanying diagrams, in which:

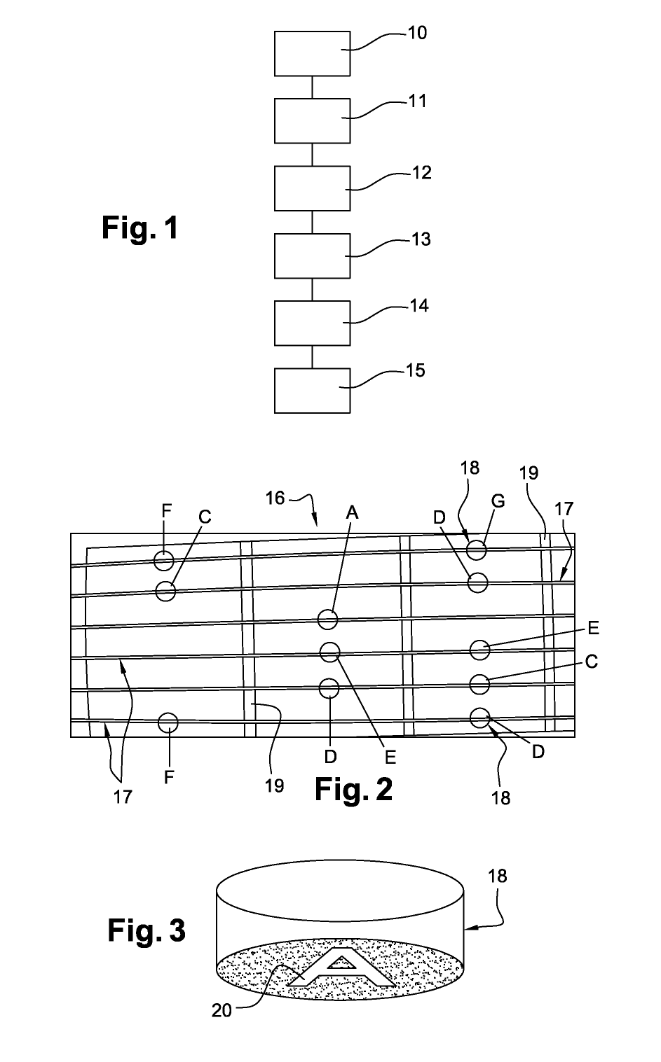

FIG. 1 is a flowchart illustrating the main manufacturing method steps for a guitar neck in accordance with an embodiment specific to the invention;

FIG. 2 is a partial view from above of neck of said guitar obtained by said manufacturing method in FIG. 1;

FIG. 3 is a schematic representation of a guide mark on the neck in accordance with another embodiment;

FIG. 1 shows a flowchart comprising the main steps leading to the manufacture of a guitar neck in accordance with an embodiment specific to the invention.

After manufacturing the neck and the fretboard, grooves are created on the fretboard in order to house the frets (Steps 1-10). Such grooves, created by cutting into the fretboard, mark the limits for the slots.

Hollows are then created in the fretboard in order to house the guide mark elements (Step 2-11). Such hollows present for example, an oval crosscut in such a way as to facilitate positioning of the guide mark elements. In addition, orientation of the guide marks carried by the guide mark elements is thus made automatic, providing significant time savings in assembling said guide mark elements with said fretboard.

Said fretboard is then cemented onto the neck, for example using wood glue (Steps 3-12).

The upper face of the combines elements less obtained is rounded out by means of a sanding block in such a way as to obtain a slight rounding out, forming the radius. Finishing is then carried out, and the radius is polished using a sanding block.

Said guide mark elements are now inserted and fixed into the fretboard housings previously created (Steps 4-13). In the present case, said guide mark elements take the shape of pellets possessing an oval crosscut. Said pellets, made of polymethyl methacrylate (PMMA), are transparent and are coloured. Each comprises a sign, in the present case, a letter of the alphabet. Said sign is placed under the lower end of said pellet. In this way, once said pellet is positioned in its slot, said sign now is at distance d from the external surface of said fretboard. However, in order to be visible to the guitar player, said signs are of a size greater than ⅔ of the largest dimension of the lower face of said pellet.

By way of example, such guide mark elements are coloured and said signs are created by etching or brushing of the ends of the guide mark elements destined to be positioned in their slots; said guide mark elements are cemented into their housings, thus improving visibility of said signs. Said etching or brushing can be carried out by laser while the future pellets are still linked together in a block. Said etching or brushing aims at creating each sign on said ends. Alternatively, said signs can be created on the ends of the guide mark elements using screen printing.

Said glue for example is a wood glue such as white polyurethane mastic. The latter fills the cavity of said letter engraved by the laser for example, and provides additional colouring to the natural colouring obtained in the course of brushing or etching of the letter, using laser. Use of pigmented glue can also be envisaged.

Said guide marks are then made flush with the external surface of said fretboard, distance d being such that each sign is not flush after this step (Step 5-14).

Said fretboard is then fretted, and the ends of the frets are made flush with said fretboard's lateral edges (Step 6-15). Ends of said frets, having been made flush, are then polished and a finishing varnish is applied to the entire neck.

FIG. 2 represents the partial view from above of a guitar neck 16 obtained by the manufacturing method described above. The width at the nut is variable according to guitar models. On the neck of the electrical guitar shown in FIG. 2, it typically measures 42 mm. The guitar neck 16 comprises six strings 17. The lower E string and the upper E string (standard tuning) are less than 5 mm from the edge of the neck.

Said guide marks 18 are placed perpendicular or close to perpendicular to said strings 16 in slots marking out the notes. In the present case, they are positioned in the middle of each slot for aesthetic reasons; they could however be shifted away from said middle. Each slot is bordered by two consecutive frets 19.

FIG. 3 shows a guide mark 18 in accordance with another embodiment of the present invention. Said guide mark 18 comprises a transparent pellet, but which possesses a letter as a sign 20, created not by brushing or etching the material of which said pellet is made, but by printing the letter on the rear face of said that pellet.

Such a method however requires double calibrating: calibration of the letter 20 on the rear face of the pellet 18, and calibration of the printer. Such a method is therefore more complex and requires more time. Such a method also carries a risk of certain pellets being defective, which would generate rejects.

1. A manufacturing method for a neck of a stringed musical instrument, characterised in that at least the following steps are carried out:
a) slots are created in a fretboard,
b) said fretboard thus obtained is assembled with a neck (16),
c) in at least some of said slots, a guide mark element is inserted (18, 20) for positioning the player's finger, said guide marks (18, 20) being transparent or semitransparent, each comprising a sign (20) based at distance d from the upper face of said guide mark (18, 20),
d) said guide marks are made flush (18, 20) thus fixed with the outer surface of said fretboard, said distance d being such that said sign (20) is not flush at the end of this step.

2. A method according to claim 1, characterised in that after step d) the neck (16) thus obtained is fretted.

3. A method in accordance with claim 1, characterised in that prior to step a), grooves are created in said fretboard, said groups corresponding to the position of the frets on said fretboard.

4. A method in accordance with claim 1, characterised in that after step b) and before step c), said fretboard is given a rounded shape in order to form the radius.

5. A method in accordance with claim 1, characterised in that said slots are holes in which are inserted said guide mark elements (18, 20); glue is spread both on the lower face of said guide mark elements (18, 20) and the lower face of said fretboard ready to be assembled with said neck (16).

6. A method in accordance with claim 1, characterised in that said guide mark elements (18, 20) having a non-circular crosscut, and recesses are created that possess a shape corresponding to said guide mark elements (18, 20) in the course of step a).

7. A method in accordance with claim 1, characterised in that said guide mark elements (18, 20) are coloured and said signs (20) are created by brushing, etching or by screen-printing on the ends of said guide mark elements (18, 20), ready for positioning in said slots; said guide mark elements (18, 20) are fixed in the slots by gluing, which improves visibility of said signs (20).

8. A method according to claim 1, characterised in that in the course of step a), housings are created at positions defining the notes, perpendicular or nearly perpendicular to the strings to the placed.

9. A musical stringed instrument equipped with a neck obtained by the manufacturing method in accordance with claim 1.

10. A musical stringed instrument in accordance with claim 9, characterised in that said guide mark elements (18, 20) are coloured plastic pellets, said signs (20) being placed inside the volume of said pellets or on their lower face.

11. A guitar neck comprising a fretboard, characterised in that said fretboard is encrusted with pellets the colour of which represents a note, said pellets being inserted in each of the note positions, in the middle of the slot and under the string, said pellets comprising a sign corresponding to the note, such sign being oriented in such a manner as to be read by the player.

12. A guitar equipped with a guitar neck in accordance with claim 11.
